(19) United States
(12) Patent Application Publication
(10) Pub. No.: US 2013/0089719 A1
(43) Pub. Date: Apr. 11, 2013

(54) EXTERIOR PANEL FOR IMPLEMENTING EXTERIOR OF STAINLESS STEEL AND HOME APPLIANCE INCLUDING THE SAME

(71) Applicants: Sunje PARK, Kyungsangnam-do (KR); Jinsoo LEE, Kyungsangnam-do (KR); Soohyun BAE, Kyungsangnam-do (KR)

(72) Inventors: Sunje PARK, Kyungsangnam-do (KR); Jinsoo LEE, Kyungsangnam-do (KR); Soohyun BAE, Kyungsangnam-do (KR)

(73) Assignee: LG ELECTRONICS INC., Seoul (KR)

(21) Appl. No.: 13/563,897

(22) Filed: Aug. 1, 2012

(30) Foreign Application Priority Data
Aug. 5, 2011 (KR) 10-2011-0078110

(51) Int. Cl. B32B 3/10; B32B 15/04

(52) U.S. Cl. CPC B32B 3/10; B32B 15/04
USPC 428/209; 428/457

(57) ABSTRACT

Provided are an exterior panel for implementing the exterior of stainless steel and a home appliance including the external panel. The exterior panel includes a transparent layer, a first surface treatment layer, a deposition layer, and a base material layer. The transparent layer transmits light. The first surface treatment layer is formed by reforming a rear surface of the transparent layer to increase deposition characteristics. The deposition layer is formed by depositing stainless steel over the rear surface of the first surface treatment layer. The base material layer is disposed under the deposition layer.

This application claims priority to Korean Patent application no. 10-2011-0078110 filed Aug. 5, 2011, which is hereby incorporated by reference.

### BACKGROUND OF THE INVENTION

1. Field of the Invention

The present invention relates to an exterior panel for implementing the exterior of stainless steel and a home appliance including the exterior panel.

2. Description of the Related Art

Generally, home appliances such as refrigerators, washing machines, cooking appliances, air conditioners, and dish washers have main bodies and doors formed of plastics. The main body and the door are formed such that they can have various colors, textures or patterns.

In such home appliances, gentrification and design differentiation are needed according to elevated standard of living and consumer's preference. Particularly, in recent years, since not only their functions but also their designs are critical factors for consumers' purchase decisions, home appliances with various kinds of colors, textures and patterns are being developed.

For example, by making the exterior of a home appliance look similar to stainless steel, manufacturers are trying to gentrify and differentiate their products through luster, feeling of color, firmness, and sanitary feeling unique to stainless steel. For this, in a related art, metal with a low melting point, e.g., aluminum is typically deposited on a polymer film, and then paint is coated thereon. Thereafter, a laminating process is performed on polyvinyl chloride (PVC) or a steel sheet. However, these exterior panels have a great difference in color and texture compared to stainless steel. Also, there is a limitation in that exfoliation may occur during the laminating process.

### SUMMARY OF THE INVENTION

Thus, an object of the present invention is to provide an exterior panel for implementing the exterior of stainless steel and a home appliance including the exterior panel

According to an aspect of the present invention, there is provided an exterior panel of a home appliance for implementing an exterior of stainless steel, including: a transparent layer transmitting light; a first surface treatment layer formed by reforming a rear surface of the transparent layer to increase deposition characteristics; a deposition layer formed by depositing stainless steel over the rear surface of the first surface treatment layer; and a base material layer disposed under the deposition layer.

According to another aspect of the present invention, there is provided an exterior panel of a home appliance for implementing an exterior of stainless steel, including: a transparent layer transmitting light; a print layer formed by coating ink on a rear surface of the transparent layer so as to have light transmittance; a deposition layer formed by depositing stainless steel over the rear surface of the print layer; and a base material layer disposed under the deposition layer.

According to another aspect of the present invention, there is provided an exterior panel of a home appliance for implementing an exterior of stainless steel, including: a transparent layer transmitting light; a deposition layer formed by depositing stainless steel over the rear surface of the transparent layer; an adhesive layer bonding a rear surface of the deposition layer and an upper surface of the base material layer; a second surface treatment layer disposed over the rear surface of the deposition layer to increase an adhesive strength with the adhesive layer; a pattern layer formed by processing an upper surface of the transparent layer into a certain pattern; a surface protective layer for protecting an upper surface of the pattern layer; a third surface treatment layer disposed between the transparent layer and the surface protective layer to increase a bonding strength between the surface protective layer and the transparent layer.

According to another aspect of the present invention, there is provided an exterior panel of a home appliance for implementing an exterior of stainless steel, including: a transparent layer transmitting light; a base material layer; an adhesive layer bonding a rear surface of the transparent layer and an upper surface of the base material layer; a fourth surface treatment layer disposed over the rear surface of the transparent layer to increase an adhesive strength with the adhesive layer; a first surface treatment layer formed by reforming an upper surface of the transparent layer so as to increase deposition characteristics; a deposition layer formed by depositing stainless steel on an upper surface of the first surface treatment layer; and a surface protective layer for protecting an upper surface of the deposition layer.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a view illustrating the cross-section of an exterior panel of a home appliance for implementing the exterior of a stainless steel according to a first embodiment of the present invention;

FIG. 2 is a view illustrating the cross-section of an exterior panel of a home appliance for implementing the exterior of a stainless steel according to a second embodiment of the present invention;

FIG. 3 is a view illustrating the cross-section of an exterior panel of a home appliance for implementing the exterior of a stainless steel according to a third embodiment of the present invention;

FIG. 4 is a view illustrating the cross-section of an exterior panel of a home appliance for implementing the exterior of a stainless steel according to a fourth embodiment of the present invention;

FIG. 5 is a view illustrating the cross-section of an exterior panel of a home appliance for implementing the exterior of a stainless steel according to a fifth embodiment of the present invention; and

FIG. 6 is a graph illustrating a comparison of color difference between an embodiment and a comparative example.

### DETAILED DESCRIPTION OF THE INVENTION

The foregoing and other objects, features, aspects and advantages of the present invention will become more apparent from the following detailed description of the present invention when taken in conjunction with the accompanying drawings. Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

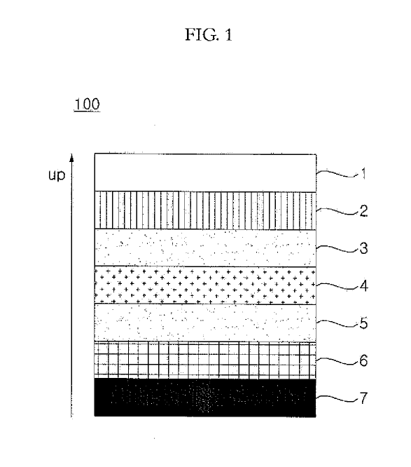

FIG. 1 is a view illustrating the cross-section of an exterior panel of a home appliance for implementing the exterior of a stainless steel according to a first embodiment of the present invention.

Referring to FIG. 1, an exterior panel 100 of a home appliance for implementing the exterior of a stainless steel according to a first embodiment may include a transparent layer 1, a pattern layer 2, a first surface treatment layer 3, a deposition layer 4, a second surface treatment layer 5, an adhesive layer 6, and a base material layer 7, which are sequentially stacked from the top.

The transparent layer 1 may be formed of a transparent or semitransparent material that allows transmission of light. Accordingly, a component disposed under or at the rear side of the transparent layer 1, particularly, the deposition layer 4 may show through the transparent layer 1. The transparent layer 1 may include a sheet or a film formed of polyethylene terephthalate (PET), polycarbonate (PC), acrylic, polyacrylonitrile (PAN), and polyvinyl chloride (PVC). The transparent layer 1 may have a light transmittance of about 80% or more

The pattern layer 2 may have a certain pattern that is formed by roll processing, hologram transcription, or laser processing. The pattern layer 2 may be disposed under the transparent layer 1. However, the pattern layer 2 may not be essential in embodiments described below. Although the pattern layer 2 is not disposed under the transparent layer 1, the exterior of the stainless steel can be implemented by the deposition layer 4 under the transparent layer 1. However, the pattern layer 2 disposed under the transparent layer 1 may serve to obtain more improved feeling of color and luster unique to metal.

The roll processing may be based on roll-to-roll processing. For example, there is a method of forming a pattern on a roll by etching or lithography and rotating the roll with the pattern to form a pattern in the transparent layer 1. Also, there is a method of forming a pattern on a roll by etching and lithography, transcribing the pattern in a film by UV or heat curing, and then using the roll as a mold to continuously form a pattern in the transparent layer 1. A hairline may be formed by the roll processing. The hairline may induce the diffused reflection of light to allow the deposition layer 4 showing through the transparent layer 1 to have a feeling of color and a luster unique to metal.

The hologram transcription method may include recording an interference pattern of light such as laser in the transparent layer 1 to reproduce a three-dimensional pattern.

The laser processing method may include forming a pattern by directly irradiating laser on the transparent layer 1.

It is possible to continuously form a certain pattern in the transparent layer 1 through a pressing process using an embossing roll.

The first surface treatment layer 3 may be formed by reforming the surface of the transparent layer 1, and may improve the deposition or adhesion characteristics of the stainless steel and improve the thermal resistance of the transparent layer 1 against the high-temperature deposition. The first surface treatment layer 3 may be formed by performing corona surface treatment or chemical treatment on the surface of the transparent layer 1. In this embodiment, the first surface treatment layer 3 may be disposed at the rear surface of the transparent layer 1.

The corona surface treatment may include activating the surface of the transparent layer 1 to improve the hydrophilicity, adhesion, printability, coating characteristics, and deposition characteristics and enable the removal of surface oil, promotion of surface breathe of a resin additive, and change of surface roughness.

The chemical treatment may include coating a thermal resistant chemical treatment agent for high-temperature deposition on the transparent layer 1.

The deposition layer 4 may be formed by depositing stainless steel. In this embodiment, the gas phase stainless steel may be deposited on the rear surface of the first surface treatment layer 3. The deposition layer 4 may be formed by E-beam evaporation. More specifically, E-beam irradiated from a filament may collide with a crucible containing stainless steel to generate heat, which enables the deposition of the stainless steel.

The second surface treatment layer 5 may improve the adhesive strength or bonding strength between the deposition layer 4 and the adhesive layer 6, and may protect the surface of the deposition layer 4 from scratches. The second surface treatment layer 5 may be formed by coating a chemical treatment agent with water resistance, salt water resistance, acid resistance, thermal resistance, corrosion resistance, curability on the deposition layer 4. In this embodiment, the second surface treatment layer 5 may be disposed on the rear surface of the deposition layer 4.

The adhesive layer 6 may enable adhesion between the deposition layer 4 and the base material layer 7. As described above, since the second surface treatment layer 5 is formed on the rear surface of the deposition layer 4, the adhesive strength of the adhesive layer 6 may be improved. The adhesive layer 6 may be formed by coating an adhesive with water resistance, salt water resistance, acid resistance, thermal resistance, and curability. Particularly, when considering the characteristics of the deposition layer 4 formed at a high temperature, it is necessary to secure a stable adhesive strength even at a temperature of about 200° C. or more.

The base material layer 7 may protect the deposition layer 4, and may determine the exterior color of the exterior panel 100. The base material layer 7 may include a film (or sheet) formed of PVC, olefin, olefin elastomer, and alcohol resin. The base material layer 7 may be formed by laminating a plurality of films (or sheets) or coating a liquid resin on a film (or sheet).

The base material layer 7 may be completely and optically blocked by the deposition layer 4. However, the color of the base material layer 7 may show through the deposition layer 4 by allowing the deposition layer 4 to have light transmittance. Thus, it is possible to implement various colors of the exterior panel 100 according to the color of the base material layer 7. In order to optimize the color variation while implementing the material characteristics of the stainless steel, the deposition layer 4 may have an optical density of about 0.5 OD to about 2.0 OD.

Also, the base material layer 7 has a color but is not limited to any one of opaque, transparent, and semitransparent one.

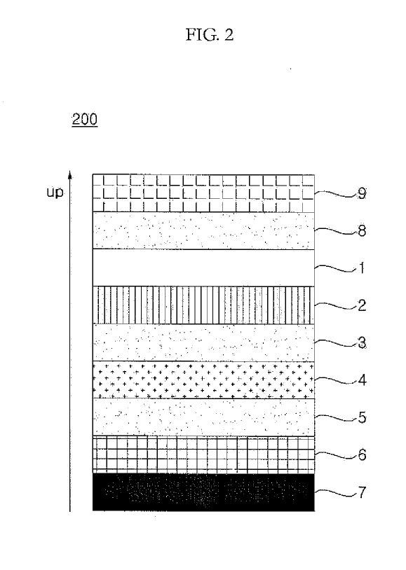

FIG. 2 is a view illustrating the cross-section of an exterior panel of a home appliance for implementing the exterior of a stainless steel according to a second embodiment of the present invention.

Hereinafter, the equal reference numerals will be given to components equal to those of the previous embodiment, and detailed descriptions thereof will be omitted below.

An exterior panel 200 of a home appliance for implementing the exterior of stainless steel according to a second embodiment of the present invention may further include a third surface treatment layer 8 and a surface protective layer 9 in addition to the components of the exterior panel 100 according to the first embodiment.

The surface protective layer 9 may protect the upper surface of a transparent layer 1 from external stimuli such as scratches, and may provide physical properties to the surface of the exterior panel 200. The surface protective layer 9 needs to be suitable for fingerprint resistance, contamination resistance, and luster correction. For example, the surface protective layer 9 may be formed by coating UV or thermally-cured coating agent over the upper surface of the transparent layer 1. Particularly, the surface protective layer 9 needs to have curability after forming of a coating film, and may be formed using a coating agent having a surface hardness of F to 3H. The surface protective layer 9 may be transparent or semitransparent.

The third surface treatment layer 8 may be disposed between the transparent layer 1 and the surface protective layer 9 to increase the adhesive force between the transparent layer 1 and the surface protective layer 9. The third surface treatment layer 8 may be formed by coating a chemical treatment agent with water resistance, salt water resistance, acid resistance, corrosion resistance, and curability to reform the upper surface of the transparent layer 1.

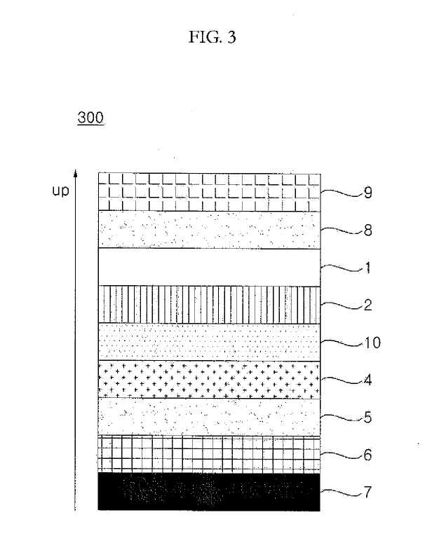

FIG. 3 is a view illustrating the cross-section of an exterior panel of a home appliance for implementing the exterior of a stainless steel according to a third embodiment of the present invention.

Hereinafter, the equal reference numerals will be given to components equal to those of the previous embodiments, and detailed descriptions thereof will be omitted below.

An exterior panel 300 of a home appliance for implementing the exterior of stainless steel according to a third embodiment of the present invention may include a print layer 10 instead of the first surface treatment layer 3 of the exterior panel 200 according to the second embodiment.

The print layer 10 may be disposed between a deposition layer 4 and a transparent layer 1. Particularly, the print layer 10 may be formed by coating ink on a pattern layer 2 after the pattern layer 2 is formed on the rear surface of the transparent layer 1. The ink may include one of pigment and dye. The pigment may be nontoxic.

The print layer 10 may have light transmittance so as to show the deposition layer 4 or a base layer 7 therethrough. The print layer 10 may have a haze smaller than about 2 and a light transmittance equal to or greater than 70%. The coating of the ink may have a thickness of about 1 μm to about 10 μm.

The print layer 10 may be formed to have various colors. The exterior panel 300 may have metallic luster unique to stainless steel, and have various colors as a whole according to the colors of the print layer 10 and/or the base material layer 7.

When stainless steel is deposited on the print layer 10, the deposition strength and the adhesive strength may be greater than the stainless steel is directly deposited on the rear surface of the transparent layer 1 (particularly, pattern layer 2).

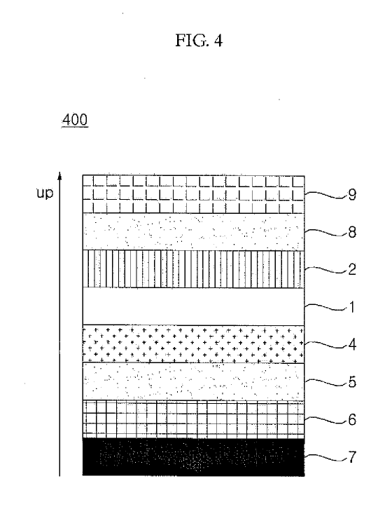

FIG. 4 is a view illustrating the cross-section of an exterior panel of a home appliance for implementing the exterior of a stainless steel according to a fourth embodiment of the present invention.

Hereinafter, the equal reference numerals will be given to components equal to those of the previous embodiments, and detailed descriptions thereof will be omitted below.

An exterior panel 400 of a home appliance for implementing the exterior of a stainless steel according to a fourth embodiment may include a surface protective layer 9, a third surface treatment layer 8, a pattern layer 2, a transparent layer 1, a deposition layer 4, a second surface treatment layer 5, an adhesive layer 6, and a base material layer 7, which are sequentially stacked from the top.

Unlike the previous embodiments, the pattern layer 2 may be disposed on the transparent layer 1. Accordingly, the surface protective layer 9 may be disposed to protect the pattern layer 2. The third surface treatment layer 8 may be formed by reforming the surface of the pattern layer 2 to improve the adhesive strength or the bonding strength of the surface protective layer 9.

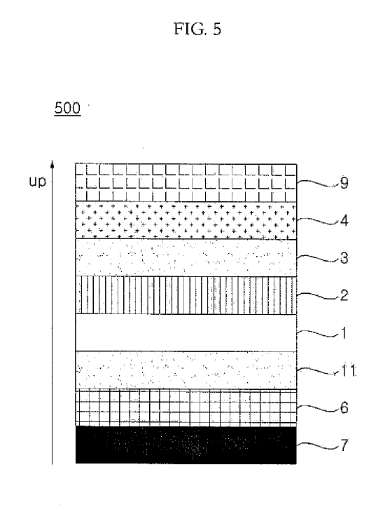

FIG. 5 is a view illustrating the cross-section of an exterior panel of a home appliance for implementing the exterior of a stainless steel according to a fifth embodiment of the present invention.

Hereinafter, the equal reference numerals will be given to components equal to those of the previous embodiments, and detailed descriptions thereof will be omitted below.

An exterior panel 500 of a home appliance for implementing the exterior of a stainless steel according to a fifth embodiment may include a surface protective layer 9, a deposition layer 4, a first surface treatment layer 3, a pattern layer 2, a transparent layer 1, a fourth surface treatment layer 11, an adhesive layer 6, and a base material layer 7, which are sequentially stacked from the top.

The pattern layer 2 may be disposed on the transparent layer 1. The first surface treatment layer 3 may be formed by reforming the surface of the pattern layer 2 such that stainless steel can be firmly deposited on the pattern layer 2. The surface protective layer 9 may be disposed to protect the deposition layer 4.

The fourth surface treatment layer 11 may be formed by reforming the rear surface of the transparent layer 1. The fourth surface treatment layer 11 may be disposed to improve the adhesive strength or the bonding strength of the adhesive layer 6.

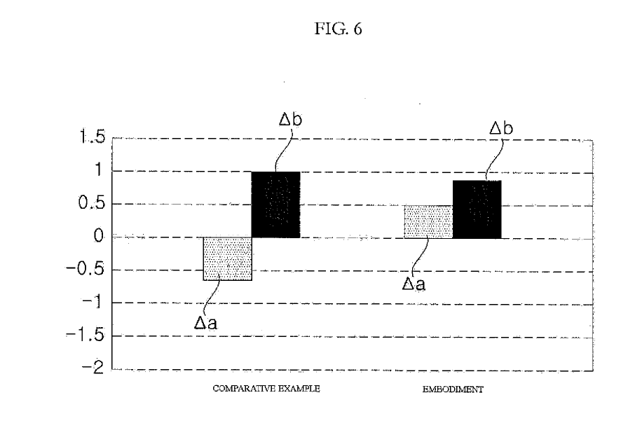

FIG. 6 is a graph illustrating a comparison of color difference between an embodiment and a comparative example.

In the embodiment and the comparative example of FIG. 6, the transparent layer 1 was disposed over the base material layer 7 having the same color. In case of the comparative example, aluminum was deposited on the transparent layer 1. However, in case of the embodiment, stainless steel was deposited on the transparent layer 1.

FIG. 6 shows color differences of stainless steel sheets (for example, stainless laminated steel sheets containing nickel of about 2.5%) that were measured under a D65 light source using a color-difference meter between the comparative example and the embodiment. The measured values of the color-difference meter conforms to the CIE L*a*b* calorimetric system of International Commission on Illumination (CIE). The graph of FIG. 6 shows Δa and Δb in which a* and b* values directly associated with the material characteristics of stainless steel are compared with the stainless steel sheet.

As shown in the graph of FIG. 6, Δa and Δb of the embodiment are smaller than those of the comparative example. This means that the embodiment represents a to feeling of color more similar to an actual stainless steel sheet.

The exterior panels and home appliances including the same according to the embodiments described above can be implemented to have exteriors extremely similar to actual stainless steel sheets.

Also, the exterior panels and home appliances including the same can prevent layers constituting the exterior panels from peeling off during the laminating process.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. An exterior panel of a home appliance for implementing an exterior of stainless steel, comprising:
a transparent layer transmitting light;
a first surface treatment layer formed by reforming a rear surface of the transparent layer to increase deposition characteristics;
a deposition layer formed by depositing stainless steel over the rear surface of the first surface treatment layer; and
a base material layer disposed under the deposition layer.

2. The exterior panel of claim 1, wherein the first surface treatment layer is formed by performing corona surface treatment on the rear surface of the transparent layer.

3. The exterior panel of claim 1, wherein the first surface treatment layer is formed by treating the rear surface of the transparent layer using a thermal resistance chemical agent.

4. The exterior panel of claim 1, further comprising a pattern layer formed by processing the rear surface of the transparent layer into a certain pattern,
wherein the first surface treatment layer is formed by reforming a surface of the pattern layer.

5. The exterior panel of claim 4, wherein the pattern formed in the pattern layer is formed by roll process, hologram transcription, or laser processing.

6. The exterior panel of claim 1, further comprising:
an adhesive layer bonding a rear surface of the deposition layer and an upper layer of the base material layer; and
a second surface treatment layer disposed over the rear surface of the deposition layer to improve an adhesive strength of the adhesive layer.

7. The exterior panel of claim 1, wherein the base material layer has a certain color, and the deposition layer has an optical density at which the color of the base material layer is transmittable.

8. The exterior panel of claim 7, wherein the optical density ranges from about 0.5 OD to about 2.0 OD.

9. The exterior panel of claim 1, further comprising:
a surface protective layer for protecting an upper surface of the transparent layer; and
a third surface treatment layer disposed between the transparent layer and the surface protective layer to increase an adhesive strength between the surface protective layer and the transparent layer.

10. The exterior panel of claim 9, wherein the surface protective layer is formed by UV coating or thermally cured coating.

11. An exterior panel of a home appliance for implementing an exterior of stainless steel, comprising:
a transparent layer transmitting light;
a print layer formed by coating ink on a rear surface of the transparent layer so as to have light transmittance;
a deposition layer formed by depositing stainless steel over the rear surface of the print layer; and
a base material layer disposed under the deposition layer.

12. The exterior panel of claim 11, wherein the print layer has a light transmittance equal to or greater than about 70%.

13. The exterior panel of claim 11, wherein the print layer has a coating thickness of about 1 μm to about 10 μm.

14. The exterior panel of claim 11, wherein the print layer has a haze smaller than about 2.

15. An exterior panel of a home appliance for implementing an exterior of stainless steel, comprising:
a transparent layer transmitting light;
a deposition layer formed by depositing stainless steel over the rear surface of the transparent layer;
a base material layer;
an adhesive layer bonding a rear surface of the deposition layer and an upper surface of the base material layer;
a second surface treatment layer disposed over the rear surface of the deposition layer to increase an adhesive strength with the adhesive layer;
a pattern layer formed by processing an upper surface of the transparent layer into a certain pattern;
a surface protective layer for protecting an upper surface of the pattern layer;
a third surface treatment layer disposed between the transparent layer and the surface protective layer to increase a bonding strength between the surface protective layer and the transparent layer.

16. An exterior panel of a home appliance for implementing an exterior of stainless steel, comprising:
a transparent layer transmitting light;
a base material layer;
an adhesive layer bonding a rear surface of the transparent layer and an upper surface of the base material layer;
a fourth surface treatment layer disposed over the rear surface of the transparent layer to increase an adhesive strength with the adhesive layer;
a first surface treatment layer formed by reforming an upper surface of the transparent layer so as to increase deposition characteristics;
a deposition layer formed by depositing stainless steel on an upper surface of the first surface treatment layer; and
a surface protective layer for protecting an upper surface of the deposition layer.

17. The exterior panel of claim 16, further comprising layer formed by processing the upper surface of the transparent layer into a certain pattern,
wherein the first surface treatment layer is formed by treating an upper surface of the pattern layer.

18. A home appliance comprising an exterior panel according to claim 1.

19. A home appliance comprising an exterior panel according to claim 11.

20. A home appliance comprising an exterior panel according to claim 15.
